(19) United States
(12) Patent Application Publication
(10) Pub. No.: US 2006/0184426 A1
(43) Pub. Date: Aug. 17, 2006

(54) Electronic transactions providing net present value

(75) Inventor: Zentaro Ohashi, Tokyo (JP)

Correspondence Address: COURTNEY STANIFORD & GREGORY LLP, P.O. BOX 9686, SAN JOSE, CA, 95157, US

(73) Assignee: Management Coach Inc., Tokyo (JP)

(21) Appl. No.: 11/059,579

(22) Filed: Feb. 15, 2005

(51) Int. Cl. G06F 17/60

(52) U.S. Cl. 705/26

(57) ABSTRACT

Electronic commerce systems and methods are described in which a customer accrues and receives an accounting of net present value (“NPV”) in exchange for purchasing goods and/or services from one or more vendors in a first group of vendors. The NPV may be in the form of monetary credits and/or rebates. The customer realizes an accrued NPV by receiving discounts and/or rebates commensurate with the NPV on purchases of goods and/or services from one or more vendors in a second group of vendors.

### FIELD OF INVENTION

The disclosure herein relates generally to electronic business transactions. In particular, this disclosure relates to systems and methods that allow a customer to realize a net present value in the form of a credit or rebate from one vendor during an electronic transaction with another vendor.

### BACKGROUND OF THE INVENTION

Electronic commerce transactions, also referred to as “e-commerce transactions” or “e-commerce”, include transactions over electronic networks between a variety of parties. The e-commerce transactions include business-to-business (“B2B”) transactions as well as business-to-consumer (“B2C”) transactions. While B2B transactions take place between two or more businesses or companies, B2C transactions are typically those in which any vendor or business sells its products or services to consumers over the Internet (“online”) for their personal use. In addition to these online vendors, B2C has grown to include services such as online banking, travel services, online auctions, health information, and even real estate sites for example.

Numbers of e-commerce transactions have significantly increased as consumers and vendors alike have become accustomed to the ease, convenience, and variety available with the online shopping offered via e-commerce. The typical electronic transaction for a consumer involves navigating to a vendor's electronic site (“online site” or “web site”) on the Internet or World Wide Web (referred to as the “web”) via the consumer's client device (e.g., a personal computer (“PC”)). Once at the site, the consumer is provided with product and purchasing information on a variety of goods and/or services offered by and/or through the particular online vendor. Consequently consumers often look to the Internet to find comprehensive product information, competitive prices and easy merchandise/service purchase and delivery.

While the proliferation of online vendors and online information has provided consumers with many choices, it has also overloaded consumers so that they often become frustrated with the online shopping experience. Likewise, the large number of online advertisements for goods and services combined with the increased price of online advertising has made it very difficult for vendors to advertise in such a way as to ensure success in reaching potential customers. Consequently, there is a need for e-commerce transactions that improve the ability of online vendors to target and attract potential customers while reducing vendor overhead associated with advertising and diluted pricing.

### SUMMARY OF THE INVENTION

The invention provides electronic commerce systems and methods in which customers accrue and receive an accounting of net present value (“NPV”) in exchange for purchasing goods and/or services from various vendors. The NPV may be in the form of monetary credits and/or rebates. The customer realizes an accrued NPV by receiving discounts and/or rebates commensurate with the NPV on purchases of goods and/or services from among different.

In a preferable embodiment of the invention, systems comprising an electronic commerce site are coupled to a first vendor site and a second vendor site over a network. The electronic commerce site can transmit information of an offer from the first vendor site to a client device of a customer when the client device accesses the second vendor site. The offer may include information related to goods and services offered for sale at the first vendor site, including discounts corresponding to the goods and services offered for sale. Furthermore, a message can be transmitted to the first vendor site indicating acceptance of the offer in response to receipt of an electronic message from the client device indicating acceptance of the offer. In response to the acceptance the second vendor site, there can be a reduction of the purchase price for the goods and services offered for sale at the second vendor site by an amount commensurate with the discount.

Other embodiments of the invention provides methods for conducting electronic commerce activity by transmitting information of an offer from a first vendor to a client device accessing an electronic site of a second vendor. The offer can include information of at least one of goods and/or services offered for sale by the first vendor, and may further include a discount corresponding to at least one of goods and services offered for sale by the second vendor. An electronic message can be received from the client device at the electronic site of the second vendor, the electronic message indicating acceptance of the offer. Thereafter, the purchase price can be reduced of at least one of the goods and services offered for sale by the second vendor in response to the electronic message, wherein the reducing is commensurate with the discount. The message can then be transmitted to an electronic site of the first vendor indicating acceptance of the offer.

Another aspect of the invention provides apparatus for conducting electronic commerce activities. Such apparatus can include means for transmitting information of an offer from a first vendor to a client device accessing an electronic site of a second vendor. The offer can include information of at least one of goods and services offered for sale by the first vendor, and also the offer can further include a discount corresponding to at least one of goods and services offered for sale by the second vendor. In addition, the system can include means for receiving an electronic message from the client device that indicates acceptance of the offer, and means for reducing a purchase price of at least one of the goods and services offered for sale by the second vendor in response to the electronic message. The amount of reduction in the purchase price can be selectively established and commensurate with applicable discounts. The electronic systems herein may further include means for transmitting a message to an electronic site of the first vendor indicating acceptance of the offer.

Other goals and advantages of the invention will become apparent from the following detailed description and accompanying figures. While the following description may contain specific details describing particular embodiments of the invention, these should not be construed as limitations on the scope of the invention in any way. This specification serves to exemplify only some of the embodiments of the invention. For each aspect of the invention, many variations are possible other than those expressly described and suggested herein which are known to those of ordinary skill in the art. It shall be understood that such changes and modifications fall within the scope and spirit of the present invention.

### BRIEF DESCRIPTION OF THE FIGURES

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings of which:

FIG. 1 is a block diagram of an NPV system that includes an NPV online site, under an embodiment.

FIG. 2 is a flow diagram of an NPV transaction, under an embodiment.

FIG. 3 is a flow diagram of information flows in an NPV transaction, under an embodiment.

FIG. 4 is a block diagram of NPV transaction information flows, under an embodiment.

FIG. 5 is a flow diagram of an NPV transaction that includes use of an NPV account, under an embodiment.

FIG. 6 is an Unrealized NPV Statement of a first example, under an embodiment.

FIG. 7 is a revised Unrealized NPV Statement, under an embodiment.

FIG. 8 is a flow diagram of NPV transaction information flows that include the use of an NPV account, under an embodiment.

FIG. 9 is a block diagram of NPV system information flows for an NPV system that includes the use of an NPV account, under an embodiment.

FIG. 10 is a computer system hosting one or more components of the NPV system that includes the NPV site, under an embodiment.

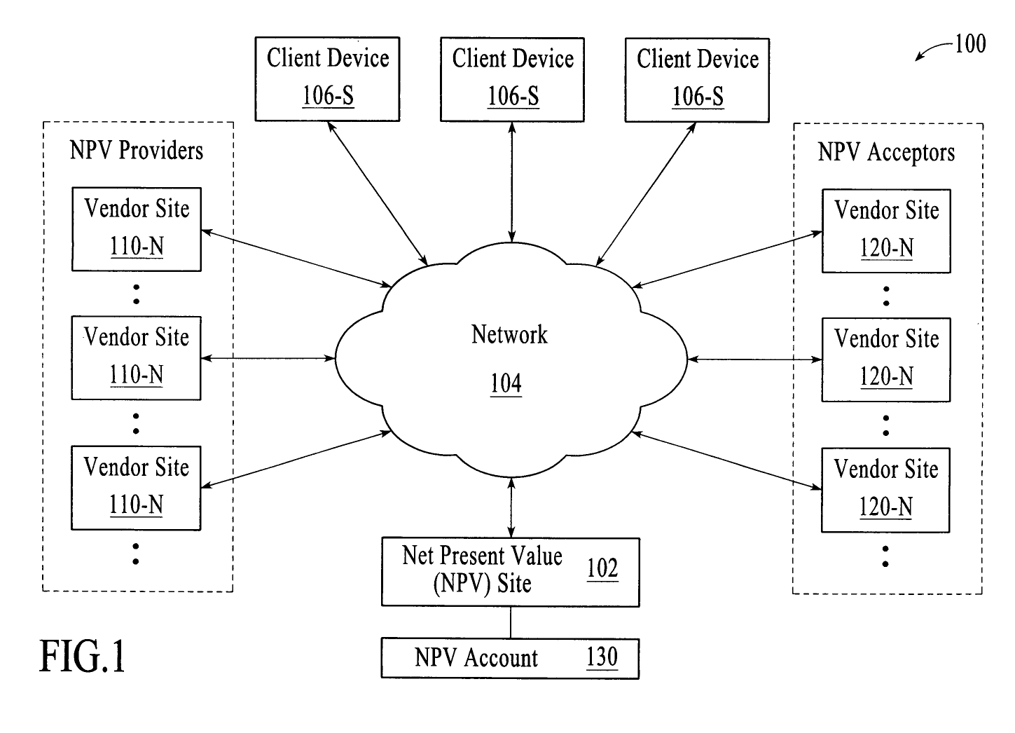

In the drawings, the same reference numbers identify identical or substantially similar elements or acts. To easily identify the discussion of any particular element or act, the most significant digit or digits in a reference number refer to the Figure number in which that element is first introduced (e.g., element 102 is first introduced and discussed with respect to FIG. 1).

### DETAILED DESCRIPTION OF THE INVENTION

E-commerce systems and methods are described below in which a Net Present Value (“NPV”) system provides customers with information on goods and/or services available from an online vendor and allows accounting of discount value by the customer for use when shopping with different online vendors. The NPV system generally provides a customer shopping online with information on available goods and/or services and corresponding discounts available from online vendors of a first group (referred to as “NPV providers”). Customer selection of one or more of the goods and/or services for purchase from NPV providers results in award of a credit or value (referred to herein as the “Net Present Value”) to the customer. The NPV may be in the form of monetary credits and/or rebates but is not so limited. An accounting of the NPV of multiple purchases may be provided to the customer. The customer uses the NPV to receive discounts and/or rebates on purchases of goods and/or services from online vendors of a second group (referred to as “NPV acceptors”).

The NPV system provides a number of different e-commerce transactions through which the customer receives the NPV. E-commerce transactions that include the use of NPV or components of the NPV system are collectively referred to herein as “NPV transactions”. In one type of NPV transaction described below, NPV providers present information of their goods and/or services and the corresponding NPV at online sites of NPV acceptors. Therefore, a customer accessing any of the NPV acceptor online sites may be presented with and select one or more of the goods and/or services via the NPV acceptor online site in order to receive the corresponding NPV. The customer may then realize any accrued or accumulated NPV in the form of discounts and/or rebates commensurate with the NPV on purchases of goods and/or services from one or more NPV acceptor online sites.

A second type of NPV transaction includes transactions in which customers access one or more NPV sites in order to provide personal information. The customer may activate or open an account with the NPV site but is not required to do so. The NPV site provides NPV offers to the customer in response to provided items of personal information, where the NPV offers include information of the goods and/or services available from NPV providers and the corresponding NPV (collectively referred to herein as “NPV information”). The goods and/or services of the NPV offers presented to the customer are selected as those in which the customer may be interested based on the personal information received at the NPV site. The NPV site may also provide information about vendors that accept the NPV as some portion of payment for their goods and/or services by providing discounts and/or rebates commensurate with the NPV on purchases.

The NPV transactions thus associate a customer with two or more vendors in a transaction that allows one vendor (NPV provider) to present goods/services with a discount (NPV) via a second vendor's (NPV acceptor) online site or an NPV site. In this transaction the NPV functions to attract customers to both purchase goods/services from the NPV provider so as to receive the NPV, and to realize the discount/rebate of the NPV through the purchase of goods/services from the NPV acceptor. Furthermore, the NPV providers realize reduced price dilution because they receive advertising through the presentation of their goods/services at the NPV acceptors online site without discounting their prices. The NPV system and transactions therefore improve the ability of online vendors to target and attract potential customers while reducing vendor overhead associated with advertising and diluted pricing.

In the following description, numerous specific details are introduced to provide a thorough understanding of, and enabling description for, embodiments of the NPV system and methods. One skilled in the relevant art, however, will recognize that these embodiments can be practiced without one or more of the specific details, or with other components, systems, etc. In other instances, well-known structures or operations are not shown, or are not described in detail, to avoid obscuring aspects of the disclosed embodiments.

FIG. 1 is a block diagram of an NPV system 100 that includes an NPV online site 102, under an embodiment. The NPV system 100, also referred to as the “NPV electronic commerce system” or “NPV e-commerce system,” uses the NPV online or electronic site 102 to provide the NPV transactions as described herein. The NPV system 100 further includes associations with a number of independent third party vendors (referred to herein as “vendors”). The vendors include individuals and/or organizations that sell goods and/or services to customers, where the vendors use one or more e-commerce sites 110-N and 120-N on the Internet (where N represents any one of a number of vendors 0, 1, 2 . . . X). These vendor e-commerce sites 110-N and 120-N are referred to herein as “vendor sites”, and may alternatively be referred to as “vendor online sites” or “vendor electronic sites”. The vendors include the NPV providers and NPV acceptors.

The NPV site 102 communicates with the vendors and/or vendor sites 110-N/120-N using at least one coupling over at least one network 104. The network 104 includes various network components (not shown) of one or more communication service providers or carriers, but is not so limited. Further, the network 104 and corresponding network components can be any of a number/combination of network types known in the art including, but not limited to, the Internet, proprietary networks, local area networks (“LANs”), metropolitan area networks (“MANs”), wide area networks (“WANs”), and backend networks for example. Additionally, the network 104 may include hybrid networks that use the Internet for some portion of the communications routing, for example, while using one or more different networks for other portions of the communications routing. The NPV site 102 couples with the network 104 using one of wired, wireless, and hybrid wired/wireless couplings or connections, and may use any number of communication systems and protocols known in the art.

In addition to associations with vendors via vendor online sites 110-N/120-N, the NPV system 100 includes associations with customers via client devices 106-S (where S represents any one of a number of customers/client devices 0, 1, 2 . . . Y). The customers include individuals and/or organizations that purchase goods and/or services from the vendors. The customers purchase goods and/or services by accessing the vendor sites 110-N/120-N using the client devices 106-S, but are not limited to these types of purchases. Customers may have an NPV account 130, as described below, but are not so required. Components of the NPV system 100 including the NPV site 102 communicate with the client devices 106-S via the network 104 as described above with reference to communications with the vendor sites 110-N/120-N. The client devices 106-S include processor-based devices like, for example, PCs, portable computing devices, personal digital assistants, communication devices, cellular telephones, portable telephones, portable communication devices, and subscriber devices or units. The client devices 106-S can include all such devices and equivalents, and are not limited to any particular type of processor-based electronic device.

As described above, the NPV system 100 provides NPV transactions during which a customer receives or accumulates NPV in exchange for purchasing or agreeing to purchase goods and/or services from one or more vendors in a first group of vendors 110-N. The NPV may be in the form of monetary credits but is not so limited. The customer realizes an accrued NPV by receiving discounts and/or rebates commensurate with the NPV on purchases of goods and/or services from one or more vendors in a second group of vendors 120-N. Thus, the NPV system 100 of an embodiment organizes the vendors into groups according to whether a vendor is an “NPV provider 110-N” (provide NPV to customers purchasing their goods/services) or whether a vendor is an “NPV acceptor 120-N” (accept NPV in exchange for a commensurate discount and/or rebate to customers purchasing their goods/services). While each vendor associated with the NPV system 100 is generally either an NPV provider 110-N or an NPV acceptor 120-N, particular vendors may be both NPV providers and NPV acceptors.

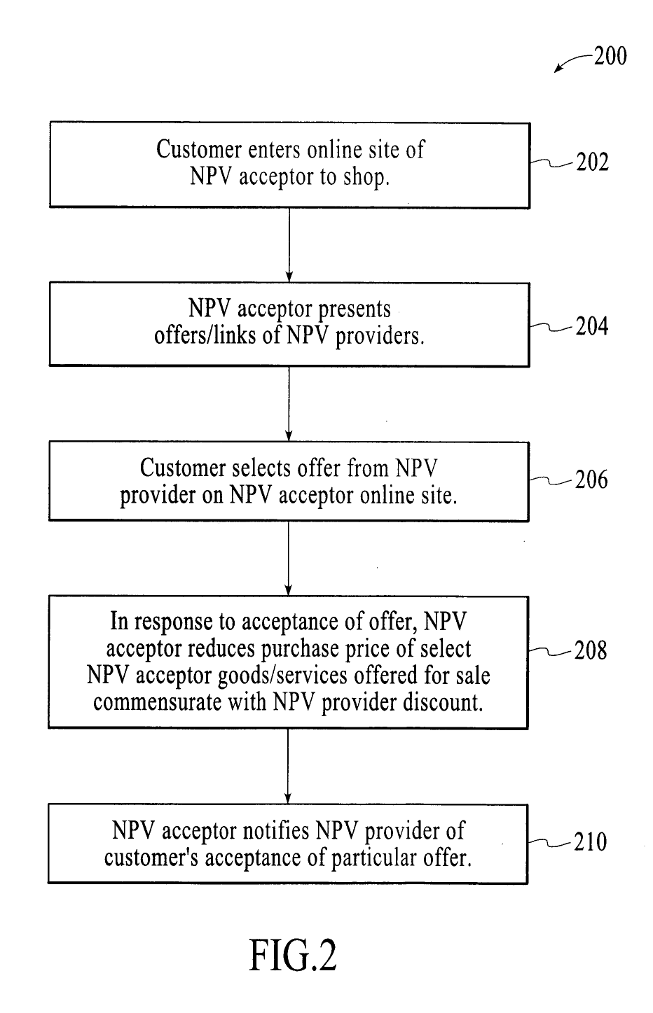

The NPV system 100 of an embodiment allows customers to participate in NPV transactions regardless of whether the customer has an account 130 (referred to herein as an “NPV account 130”) with the NPV site 102. As one example of NPV transactions outside of an NPV account, FIG. 2 is a flow diagram of an NPV transaction 200, under an embodiment. The NPV transaction 200 generally begins when a customer accesses a vendor online site of an NPV acceptor on which he/she plans to shop, at block 202. The NPV acceptor presents to the customer NPV information that includes information of offers for goods and/or services available from various NPV providers, at block 204, and each offer for goods and/or services includes a corresponding NPV amount.

The NPV information may be displayed on the NPV acceptor online site as associated with a particular good and/or service or may generally be available with any goods and/or services offered for sale on the NPV acceptor online site. The NPV information provides information of offers for goods and/or services from one or more other vendors that are NPV providers, and includes at least one of an appropriately labeled pull-down menu, drop-down menu, push media, pull media, and dynamic ad units, but is not so limited. Each offer for goods and/or services includes an NPV amount associated with selection of that offer. The NPV amount can be any type of currency in any denomination.

Continuing, the customer selects one of the NPV offers on the NPV acceptor online site, at block 206. In response to the customer selection or acceptance of the NPV offer, the NPV acceptor discounts the price of their corresponding goods and/or services commensurate to the NPV of the selected NPV offer, at block 208. Simultaneous with or subsequent to the customer's selection of a particular NPV offer, the NPV acceptor notifies the NPV provider of the customer selection, at block 210. The NPV provider uses information of the customer provided via the NPV acceptor to contact the customer and initiate the transaction for sale of the NPV provider's goods and/or services.

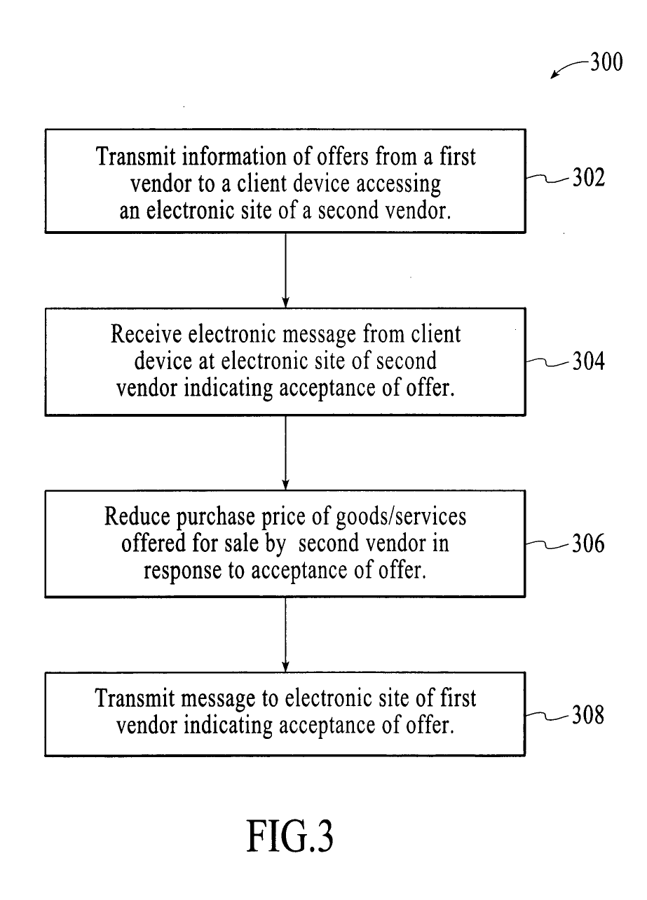

FIG. 3 is a flow diagram of information flows in an NPV transaction 300, under an embodiment. The NPV transaction flow 300 begins when, in response to a customer accessing an NPV acceptor online site, information of NPV offers is transferred from the NPV provider to the customer's client device, at block 302. The information of the NPV offers is transferred in an embodiment using at least one coupling between at least one of the client device, the NPV provider, the NPV acceptor, and the NPV site via one or more networks. When the customer selects one of the NPV offers, the NPV acceptor online site receives an electronic message from the customer's client device, at block 304. The message indicates selection or acceptance of a particular NPV offer.

In response to receipt of a message indicating customer selection of the NPV offer, the NPV acceptor online site components cause a reduction in the price of their goods and/or services that correspond to the selected NPV offer, at block 306. The price reduction may take the form of a discounted price, a rebate, or a discounted price/rebate combination, for example. The total price reduction is commensurate with the NPV of the selected NPV offer. Simultaneous with or subsequent to the price reduction, the NPV acceptor transfers an electronic message to the NPV provider, at block 308, the message notifying the NPV provider of the customer selection. As described above, the NPV provider uses information of the customer provided via the message from the NPV acceptor to initiate contact with the customer in order to follow-up on acceptance by the customer of the NPV provider's offer for goods and/or services.

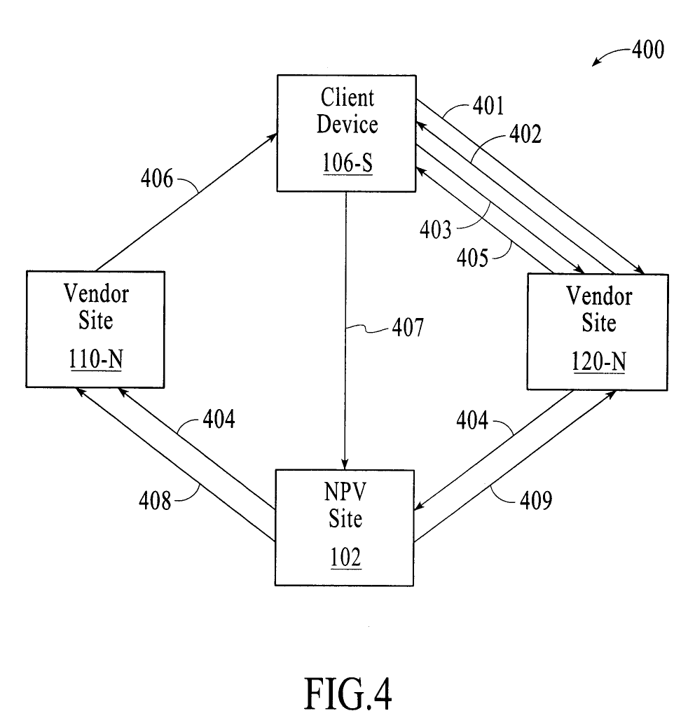

The NPV system of an embodiment can facilitate any flow of information among any combination of the components of an e-commerce system in supporting NPV transactions. As one example, FIG. 4 is a block diagram of NPV transaction information flows 400, under an embodiment. As described above, the NPV transaction 400 generally begins when a customer uses his/her client device 106-S to access 401 an NPV acceptor online site 120-N on which he/she plans to shop. The NPV acceptor site 120-N transfers 402 available NPV information to the client device 106-S. The customer selects one of the NPV offers received via the NPV acceptor online site 120-N, and information of the selection is transferred 403 to the NPV acceptor online site 120-N from the client device 106-S.

In response to the selection information from the client device 106-S, the NPV acceptor online site 120-N discounts the price of their associated goods and/or services commensurate to the NPV of the selected NPV offer. Information of the discounted price is transferred 405 to the client device 106-S. The NPV acceptor online site 120-N also transfers 404 information of the selection via the NPV site 102 to the online site 110-N of the NPV provider hosting the selected offer. Alternative embodiments of the NPV system may cause the information of the selection to be transferred to the NPV provider online site using a number of other information paths. The NPV provider uses the information received from the NPV acceptor online site 120-N to eventually contact 406 the customer via the client device 106-S and initiate the transaction for sale of the NPV provider's goods and/or services.

The NPV system of an embodiment also allows a customer using a client device 106-S to directly access 407 the NPV site 102. The NPV site 102 may directly route 408 the client device 106-S to an NPV provider online site 110-N from which the customer may initiate an NPV transaction. Further, the NPV site 102 may directly route 409 the customer to an NPV acceptor online site 120-N from which the customer may initiate an NPV transaction.

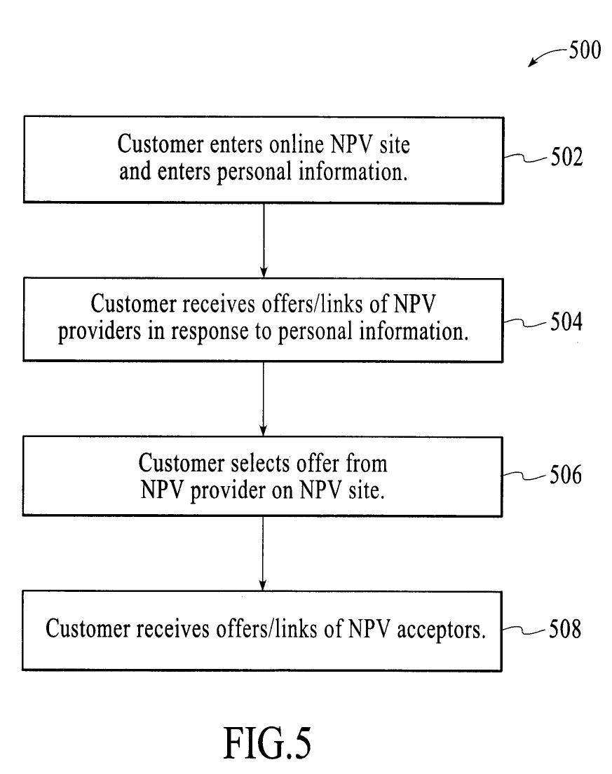

In addition to the NPV transactions described above, the NPV site 102 allows a customer to open an NPV account from which the customer may initiate the NPV transactions described herein. FIG. 5 is a flow diagram of an NPV transaction 500 that includes use of an NPV account, under an embodiment. The NPV account transaction 500 generally begins when a customer accesses the NPV site and enters personal information or other demographic information about themselves, at block 502. As an example, the personal information may include information on age, gender, address, occupation, income level, interests, hobbies, types of credit cards used, credit card balances, types of insurance policies owned (life, home, medical, dental, vision, disability, automobile, etc.), Internet service providers, cellular telephone service providers, and health information (medical, dental, vision, etc.), to name a few.

In exchange for providing personal information, the customer receives NPV information via the NPV site and the client device, at block 504. The NPV information is as described above and may include links to NPV provider online sites as appropriate. The customer may select any of the NPV offers on the NPV site, at block 506. In response to the input of personal information the customer also may receive information of offers and/or links to NPV acceptor online sites, at block 508, but is not so limited.

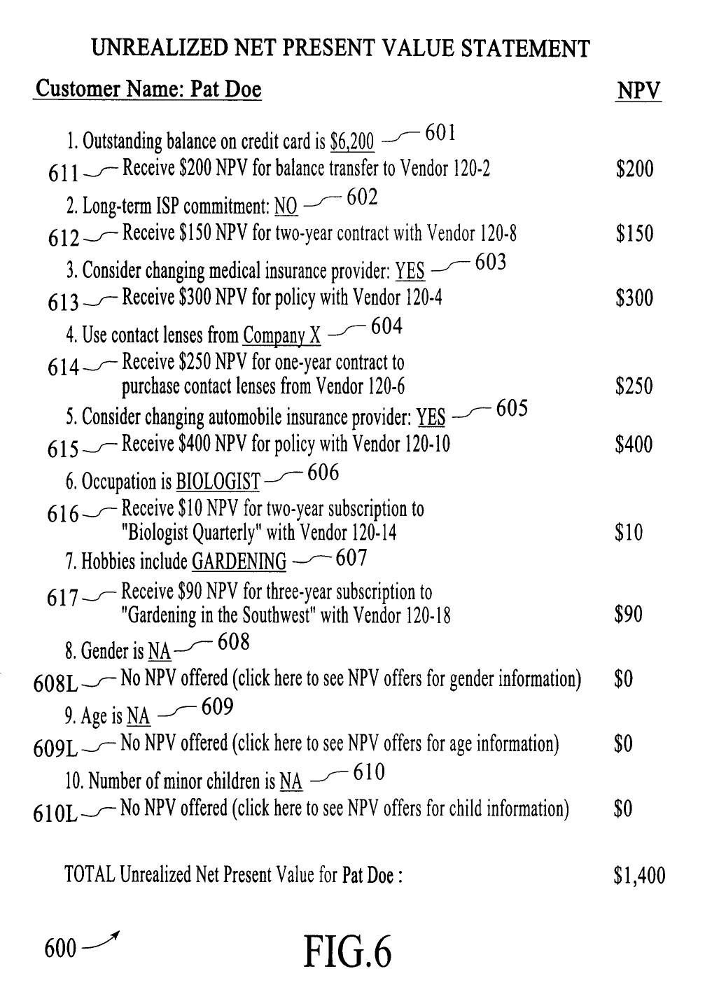

The NPV system of an embodiment presents the NPV information to a customer in the form of an “Unrealized Net Present Value Statement” or “Unrealized NPV Statement”. The Unrealized NPV Statement is an accounting of NPV and can take many forms but, as an example, may include a list of the customer's personal information items along with NPV information corresponding to one or more of the particular items of personal information. FIG. 6 is an Unrealized NPV Statement 600 of a first example, under the NPV system of an embodiment. This Unrealized NPV Statement 600 includes select items of personal information 601-607 provided by the customer along with the corresponding NPV information 611-617 (which includes the NPV amount). The personal information 601-607 results in the customer having a total Unrealized NPV of $1,400 if the customer were to take advantage of all listed NPV offers.

Referring to the Unrealized NPV Statement 600, for example, the customer indicates with personal information item 602 that he/she has no long-term Internet service provider (“ISP”) commitment. In response to item 602 the NPV site presents NPV information 612 offering the customer an NPV of $150 in exchange for a two-year contract with Vendor 120-8 (NPV provider). Likewise the customer indicates with personal information item 604 that he/she uses contact lenses of Company X. In response to item 604 the NPV site presents NPV information 614 offering the customer an NPV of $250 in exchange for a one-year contract to purchase contact lenses from Vendor 120-6 (NPV provider).

In addition to the personal information items 601-607, the Unrealized NPV statement includes three personal information items 608-610 which the customer has elected not to provide. The absence of the personal information for these items 608-610 results in an absence of NPV information. However, the NPV system may provide links 608L-610L the selection of which will present potential NPV information available to the customer providing the corresponding personal information items.

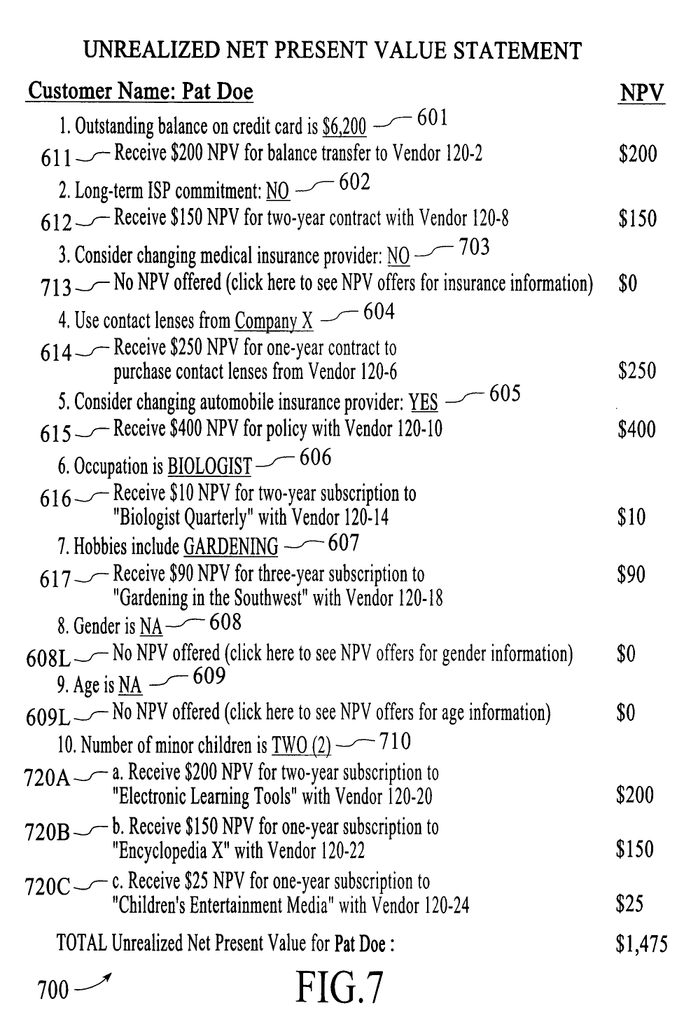

The Unrealized NPV Statement 600 of an embodiment allows the customer to directly add, delete, and/or change personal information provided to the NPV system using the statement 600. As an example, FIG. 7 is a revised Unrealized NPV Statement 700, under the NPV system of an embodiment. This revised Unrealized NPV Statement 700 includes select items of personal information 601, 602, and 604-607 provided by the customer along with the corresponding NPV information as described above with reference to FIG. 6. However, in this example statement 700 the customer changes personal information to response 703 to indicate that he/she will not consider changing his/her medical insurance provider. In response to the change in response 703, the NPV system removes the NPV ($300) associated with accepting the offer for medical insurance with Vendor 120-4 and correspondingly reduces the total Unrealized NPV.

Similarly, the customer also adds additional personal information with response 710, where instead of providing no information on number of minor children as in response 610 of statement 600, the customer now indicates with personal information item 710 that he/she has two (2) minor children. In response to the additional information provided with new response 710, the NPV system presents the customer with three different NPV offers 720A, 720B, 720C.

The first NPV offer 720A offers the customer an NPV of $200 in exchange for a two-year subscription to “Electronic Learning Tools” with Vendor 120-20 (NPV provider). The second NPV offer 720B offers the customer an NPV of $150 in exchange for a one-year subscription to “Encyclopedia X” with Vendor 120-22 (NPV provider). The third NPV offer 720C offers the customer an NPV of $25 in exchange for a one-year subscription to “Children's Entertainment Media” with Vendor 120-24 (NPV provider). The NPV system correspondingly increases the total Unrealized NPV in accordance with these additional offers 720A-720C. Thus, the personal information 601-607 and 710 results in the customer having a total Unrealized NPV of $1,475 if the customer were to take advantage of all NPV offers.

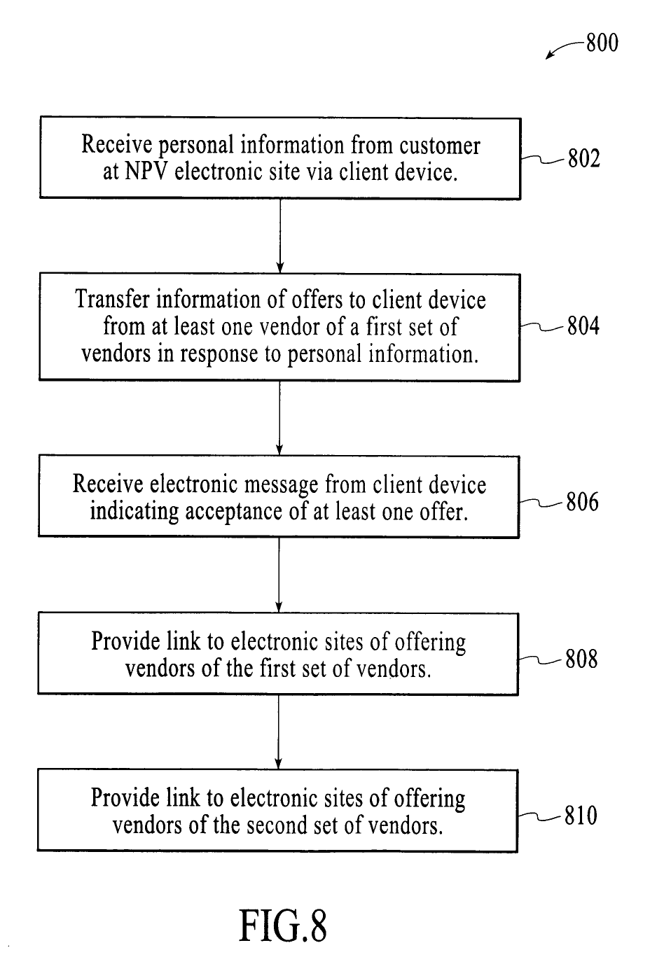

When accessing the NPV system through the NPV site instead of through one of an NPV provider or NPV acceptor online site, the information flows may be different than those described above. As an example of information flows alternative to those described above, FIG. 8 is a flow diagram of NPV transaction information flows 800 that include the use of an NPV account, under an embodiment. The transaction flow 800 begins when the customer uses his/her client device to access the NPV site, and the NPV site receives personal information of the customer, at block 802.

In response to receipt of the personal information, NPV information is transferred to the client device, at block 804. The NPV information can be in the form of an Unrealized NPV Statement as described above with reference to FIG. 6 and FIG. 7, but is not so limited. The NPV information may be transferred from the NPV site directly and/or from one or more NPV providers. The information of the NPV offers is transferred in an embodiment using at least one coupling between at least one of an NPV provider, an NPV acceptor, and the NPV site via one or more networks.

When the customer selects one of the NPV offers, the NPV site receives an electronic message from the customer's client device, at block 806. The message indicates selection or acceptance of a particular NPV offer. In response to receipt of a message indicating the customer selection of the NPV offer, the NPV site may transfer to the client device information of a link to NPV provider online sites, at block 808. Alternatively, the NPV site can redirect the client device to the NPV provider sites as appropriate to the selected NPV offer and the NPV system configuration. Also in response to receipt of a message indicating customer selection of an NPV offer, the NPV site may transfer to the client device information of links to NPV acceptor online sites, at block 810. Alternatively, the NPV site may redirect the client device to the NPV acceptor sites as appropriate to messages received from the client device.

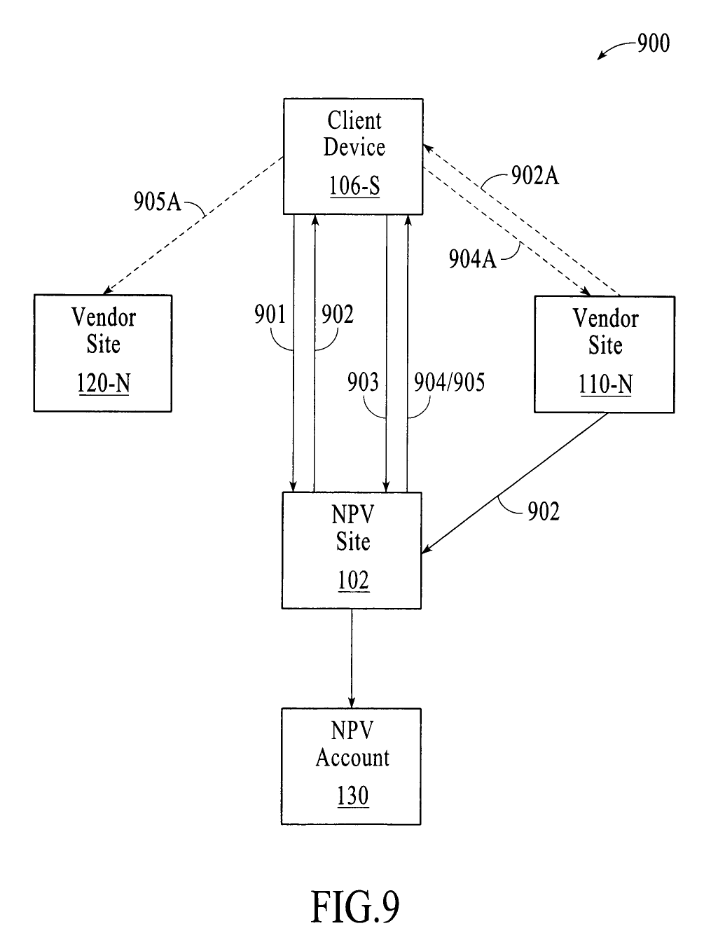

Regarding the information flows in NPV transactions using an NPV account, the NPV system of an embodiment can facilitate any flow of information among any combination of components of an e-commerce system. As one example, FIG. 9 is a block diagram of NPV system information flows 900 for an NPV system that includes the use of an NPV account, under an embodiment. As described above, the NPV transaction 900 using the NPV account generally begins when a customer uses his/her client device 106-S to access 901 the NPV site 102 and open or activate an NPV account 130 by transferring personal information to the NPV site 102 or revising personal information previously provided to the site.

In response to receipt of the personal information, the NPV site 102 transfers NPV information 902 to the client device 106-S. The NPV site 102 alternatively directs or otherwise causes the NPV provider online sites 10-N or any other online sites (not shown) hosting the NPV information to transfer 902A the NPV information to the client device 106-S.

When the customer selects NPV offers from among the NPV information, the client device 106-S transfers 903 an electronic message to the NPV site 102 that indicates selection or acceptance of the particular NPV offers. In response to receipt of a message indicating customer selection of the NPV offer, the NPV site 102 transfers 904 to the client device 106-S information of electronic links to NPV provider online sites 10-N, as appropriate to the selected offers. The customer can use the links to access 904A the NPV provider sites 110-N or, alternatively, the NPV site 102 can redirect 904A the client device 106-S to the NPV provider sites 10-N as appropriate to the selected NPV offer.

The NPV site 102 may also transfer 905 to the client device 106-S information of electronic links to NPV acceptor online sites 120-N. The client device 106-S can use the links to access 905A the NPV acceptor sites 120-N or, alternatively, the NPV site 102 can redirect 905A the client device 106-S to the NPV acceptor sites 120-N as appropriate to information received from the client device 106-S.

Referring to FIGS. 1-9, the operations of the NPV transactions are under control of at least one processor, but are not so limited. Those skilled in the relevant art can create source code, microcode, program logic arrays or otherwise implement the NPV system based on these flow diagrams and the detailed description provided herein. The algorithm or routine operating according to these flow diagrams is stored in non-volatile memory that forms part of the associated processors, in the associated memory areas, in removable media, such as disks, or hardwired or preprogrammed in chips, such as electronically erasable programmable ROM (“EEPROM”) semiconductor chips, or in any combination of these components, but is not so limited.

Aspects of the NPV system, described above, are described in terms of processes executed on one or more types of processing system. These processes are implemented as program code stored in machine-readable or computer-readable memory areas or devices of a computer system and are executed by the processor of the computer system.

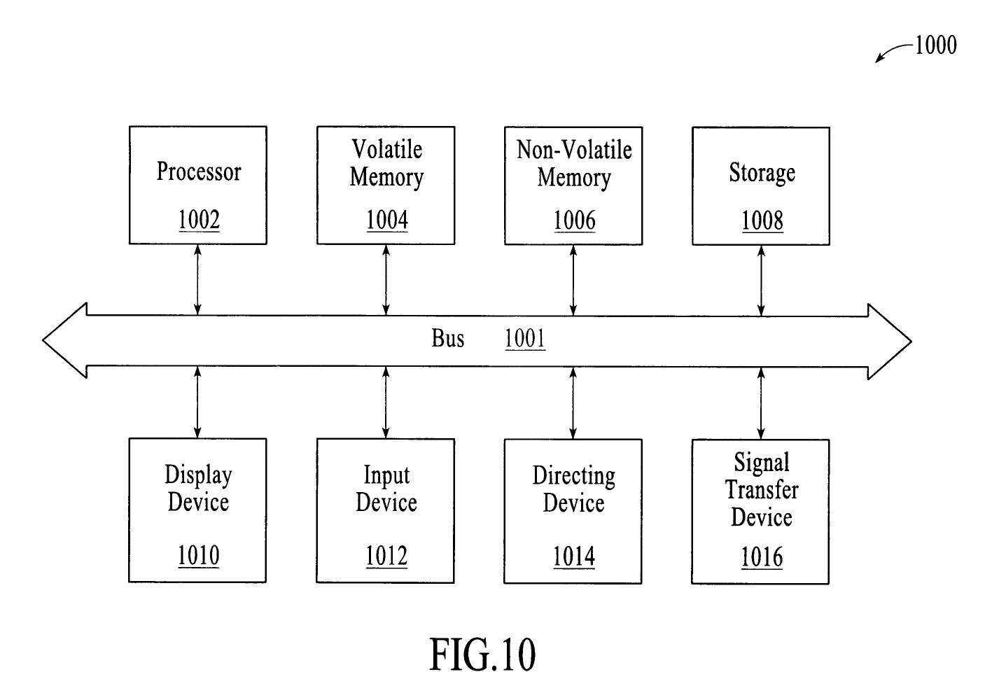

Although a variety of different computer systems can be used with the NPV system, FIG. 10 is a computer system 1000 hosting one or more components of the NPV system that includes the NPV site, under an embodiment. The computer system 1000 generally includes a central processor unit (“CPU”) or central processor 1002 for processing information and instructions, an address/data bus 1001 coupled to the CPU 1002 for communicating information, volatile memory 1004 (random access memory (“RAM”) for example) coupled to the bus 1001 for storing information and instructions for the CPU 1002, and non-volatile memory 1006 (read-only memory (“ROM”) for example) coupled to the bus 1001 for storing static information and instructions for the CPU 1002. The computer system 1000 may also include one or more optional storage devices 1008 coupled to the bus 1001 for storing information and instructions. The storage devices or data storage devices 1008 can include one or more removable magnetic or optical storage media which are computer-readable memories. Some combination of the volatile memory 1004, non-volatile memory 1006, and/or storage device 1008 include or store data structures describing components or processes of the NPV system described above, but the NPV system is not limited to storage in these devices.

The computer system 1000 may also include at least one optional display device 1010 coupled to the bus 1001 for displaying information to the users of the computer system 1000. The computer system 1000 of an embodiment may also include one or more optional input devices 1012 coupled to the bus 1001 for communicating information and command selections to the CPU 1002. Additionally, the computer system 1000 may include an optional cursor control or directing device 1014 coupled to the bus 1001 for communicating user input information and command selections to the CPU 1002. The computer system 1000 may also include one or more optional signal transfer devices 1016 (transmitter, receiver, modem, antenna, etc. for example) coupled to the bus 1001 for interfacing with other computer systems.

The NPV of an embodiment includes a system comprising an electronic commerce site that couples to a first vendor site and a second vendor site using at least one network, the electronic commerce site at least one of: transmitting information of an offer from the first vendor site to a client device of a customer when the client device accesses the second vendor site, wherein the offer includes information of at least one of goods and services offered for sale at the first vendor site and information of discounts corresponding to the goods and services offered for sale at the first vendor site; and transmitting a message to the first vendor site indicating acceptance of the offer in response to receipt of an electronic message from the client device indicating acceptance of the offer, wherein in response to the acceptance the second vendor site reduces a purchase price of at least one of goods and services offered for sale at the second vendor site by an amount commensurate with the discount.

The system of an embodiment further comprises the electronic commerce site transferring information of a net present value of the customer to the client device, the net present value representing a total value corresponding to at least one of a plurality of offers from at least one of a plurality of vendor sites, wherein the plurality of offers includes the offer and the plurality of vendor sites includes the first vendor site.

The system of an embodiment further comprises at least one of receiving personal information at the electronic commerce site from a customer via the client device and the network, and selecting the offer for transmission to the customer in response to at least one item of the personal information. The system of an embodiment further comprises at least one of receiving updated personal information at the electronic commerce site from a customer via the network, the updated personal information including at least one of changes to the personal information and additional items of personal information, and generating at least one of an updated offer and at least one additional offer in response to the updated personal information.

The system of an embodiment further comprises transmitting a contact message to the client device from the first vendor site, the contact message including information for use in forming a contractual relationship in response to acceptance of the offer.

The at least one vendor in a first vendor set of an embodiment uses the first vendor site and at least one vendor in a second vendor set uses the second vendor site, wherein the network includes at least one of the Internet and a proprietary network.

The NPV of an embodiment includes a method for electronic commerce, comprising at least one of: transmitting information of an offer from a first vendor to a client device accessing an electronic site of a second vendor, the offer including information of at least one of goods and services offered for sale by the first vendor, the offer further including a discount corresponding to at least one of goods and services offered for sale by the second vendor; receiving an electronic message from the client device at the electronic site of the second vendor, the electronic message indicating acceptance of the offer; reducing a purchase price of at least one of the goods and services offered for sale by the second vendor in response to the electronic message, wherein the reducing is commensurate with the discount; and transmitting a message to an electronic site of the first vendor indicating acceptance of the offer.

The method of an embodiment further comprises generating information of a net present value of a customer using the client device, the net present value representing a total value corresponding to at least one of the offer and additional offers available to a customer using the client device.

The method of an embodiment further comprises one or more of receiving personal information from a customer using the client device, and selecting the offer for presentation to the customer in response to an item of the personal information. The method of an embodiment further comprises generating a plurality of additional offers in response to a plurality of items of the personal information. The method of an embodiment further comprises at least one of receiving updated personal information from the customer, the updated personal information including at least one of changes to the personal information and additional items of personal information, and updating at least one offer for presentation to the customer in response to the updated personal information.

The method of an embodiment further comprises transmitting a contact message to the client device from the electronic site of the first vendor, wherein the contact message includes information for use in forming a contractual relationship between a customer using the client device and the first vendor in response to acceptance of the offer.

The first vendor of an embodiment includes at least one vendor in a first vendor set and the second vendor includes at least one vendor in a second vendor set.

The NPV of an embodiment includes an apparatus comprising at least one of: means for transmitting information of an offer from a first vendor to a client device accessing an electronic site of a second vendor, the offer including information of at least one of goods and services offered for sale by the first vendor, the offer further including a discount corresponding to at least one of goods and services offered for sale by the second vendor; means for receiving an electronic message from the client device that indicates acceptance of the offer; means for reducing a purchase price of at least one of the goods and services offered for sale by the second vendor in response to the electronic message, wherein the reducing is commensurate with the discount; and means for transmitting a message to an electronic site of the first vendor indicating acceptance of the offer.

The apparatus of an embodiment further comprises means for generating information of a net present value of a customer using the client device, the net present value representing a total value corresponding to at least one of a plurality of offers from at least one of a plurality of vendors operating vendor electronic commerce sites, wherein the plurality of offers includes the offer and the plurality of vendors includes the first and second vendor.

The apparatus of an embodiment further comprises at least one of means for receiving personal information from a customer using the client device, and means for selecting the offer for presentation to the customer in response to an item of the personal information. The apparatus of an embodiment further comprises means for generating a plurality of additional offers in response to a plurality of items of the personal information. The apparatus of an embodiment further comprises at least one of means for receiving updated personal information from the customer, the updated personal information including at least one of changes to the personal information and additional items of personal information, and means for updating at least one offer for presentation to the customer in response to the updated personal information.

The apparatus of an embodiment further comprises means for transmitting a contact message to the client device from the electronic site of the first vendor, wherein the contact message includes information for use in forming a contractual relationship between a customer using the client device and the first vendor in response to acceptance of the offer.

The first vendor of an embodiment includes at least one vendor in a first vendor set and the second vendor includes at least one vendor in a second vendor set.

Aspects of the NPV system described herein may be implemented as functionality programmed into any of a variety of circuitry, including programmable logic devices (“PLDs”), such as field programmable gate arrays (“FPGAs”), programmable array logic (“PAL”) devices, electrically programmable logic and memory devices and standard cell-based devices, as well as application specific integrated circuits (“ASICs”). Some other possibilities for implementing aspects of the NPV system include: microcontrollers with memory (such as electronically erasable programmable read only memory (“EEPROM”)), embedded microprocessors, firmware, software, etc. Furthermore, aspects of the NPV system may be embodied in microprocessors having software-based circuit emulation, discrete logic (sequential and combinatorial), custom devices, fuzzy (neural) logic, quantum devices, and hybrids of any of the above device types. Of course the underlying device technologies may be provided in a variety of component types, e.g., metal-oxide semiconductor field-effect transistor (“MOSFET”) technologies like complementary metal-oxide semiconductor (“CMOS”), bipolar technologies like emitter-coupled logic (“ECL”), polymer technologies (e.g., silicon-conjugated polymer and metal-conjugated polymer-metal structures), mixed analog and digital, etc.

It should be noted that components of the various NPV systems and methods disclosed herein may be described using computer aided design tools and expressed (or represented), as data and/or instructions embodied in various computer-readable media, in terms of their behavioral, register transfer, logic component, transistor, layout geometries, and/or other characteristics. Formats of files and other objects in which such circuit expressions may be implemented include, but are not limited to, formats supporting behavioral languages such as C, Verilog, and HLDL, formats supporting register level description languages like RTL, and formats supporting geometry description languages such as GDSII, GDSIII, GDSIV, CIF, MEBES and any other suitable formats and languages.

Computer-readable media in which components of the NPV system may be embodied include, but are not limited to, non-volatile storage media in various forms (e.g., optical, magnetic or semiconductor storage media) and carrier waves that may be used to transfer such formatted data and/or instructions through wireless, optical, or wired signaling media or any combination thereof. Examples of transfers of such formatted data and/or instructions by carrier waves include, but are not limited to, transfers (uploads, downloads, e-mail, etc.) over the Internet and/or other computer networks via one or more data transfer protocols (e.g., HTTP, FTP, SMTP, etc.). When received within a computer system via one or more computer-readable media, such data and/or instruction-based expressions of the above described systems and methods may be processed by a processing entity (e.g., one or more processors) within the computer system in conjunction with execution of one or more other computer programs.

Unless the context clearly requires otherwise, throughout the description and the claims, the words “comprise,” “comprising,” and the like are to be construed in an inclusive sense as opposed to an exclusive or exhaustive sense; that is to say, in a sense of “including, but not limited to.” Words using the singular or plural number also include the plural or singular number respectively. Additionally, the words “herein,” “hereunder,” “above,” “below,” and words of similar import refer to this application as a whole and not to any particular portions of this application. When the word “or” is used in reference to a list of two or more items, that word covers all of the following interpretations of the word: any of the items in the list, all of the items in the list and any combination of the items in the list.

The above description of illustrated embodiments of the NPV system is not intended to be exhaustive or to limit the NPV system to the precise forms disclosed. While specific embodiments of, and examples for, the NPV system are described herein for illustrative purposes, various equivalent modifications are possible within the scope of the NPV system, as those skilled in the relevant art will recognize. The teachings of the NPV system provided herein can be applied to other processing systems and methods, not only for the NPV system described above.

The elements and acts of the various embodiments described above can be combined to provide further embodiments. These and other changes can be made to the NPV system in light of the above detailed description.

In general, in the following claims, the terms used should not be construed to limit the NPV system to the specific embodiments disclosed in the specification and the claims, but should be construed to include all systems and methods that operate under the claims. Accordingly, the NPV system is not limited by the disclosure, but instead the scope of the NPV system is to be determined entirely by the claims.

While certain aspects of the NPV system are presented below in certain claim forms, the inventor contemplates the various aspects of the NPV system in any number of claim forms. Accordingly, the inventors reserve the right to add additional claims after filing the application to pursue such additional claim forms for other aspects of the NPV system.

What is claimed is:

1. A system comprising an electronic commerce site that couples to a first vendor site and a second vendor site using at least one network, the electronic commerce site:
transmitting information of an offer from the first vendor site to a client device of a customer when the client device accesses the second vendor site, wherein the offer includes information of at least one of goods and services offered for sale at the first vendor site and information of discounts corresponding to the goods and services offered for sale at the first vendor site; and
transmitting a message to the first vendor site indicating acceptance of the offer in response to receipt of an electronic message from the client device indicating acceptance of the offer, wherein in response to the acceptance the second vendor site reduces a purchase price of at least one of goods and services offered for sale at the second vendor site by an amount commensurate with the discount.

2. The system of claim 1, further comprising the electronic commerce site transferring information of a net present value of the customer to the client device, the net present value representing a total value corresponding to at least one of a plurality of offers from at least one of a plurality of vendor sites, wherein the plurality of offers includes the offer and the plurality of vendor sites includes the first vendor site.

3. The system of claim 1, further comprising:
receiving personal information at the electronic commerce site from a customer via the client device and the network; and
selecting the offer for transmission to the customer in response to at least one item of the personal information.

4. The system of claim 3, further comprising:
receiving updated personal information at the electronic commerce site from a customer via the network, the updated personal information including at least one of changes to the personal information and additional items of personal information; and
generating at least one of an updated offer and at least one additional offer in response to the updated personal information.

5. The system of claim 1, further comprising transmitting a contact message to the client device from the first vendor site, the contact message including information for use in forming a contractual relationship in response to acceptance of the offer.

6. The system of claim 1, wherein at least one vendor in a first vendor set uses the first vendor site and at least one vendor in a second vendor set uses the second vendor site, wherein the network includes at least one of the Internet and a proprietary network.

7. A method for electronic commerce, comprising:
transmitting information of an offer from a first vendor to a client device accessing an electronic site of a second vendor, the offer including information of at least one of goods and services offered for sale by the first vendor, the offer further including a discount corresponding to at least one of goods and services offered for sale by the second vendor;
receiving an electronic message from the client device at the electronic site of the second vendor, the electronic message indicating acceptance of the offer;
reducing a purchase price of at least one of the goods and services offered for sale by the second vendor in response to the electronic message, wherein the reducing is commensurate with the discount; and
transmitting a message to an electronic site of the first vendor indicating acceptance of the offer.

8. The method of claim 7, further comprising generating information of a net present value of a customer using the client device, the net present value representing a total value corresponding to at least one of the offer and additional offers available to a customer using the client device.

9. The method of claim 7, further comprising:
receiving personal information from a customer using the client device; and
selecting the offer for presentation to the customer in response to an item of the personal information.

10. The method of claim 9, further comprising generating a plurality of additional offers in response to a plurality of items of the personal information.

11. The method of claim 9, further comprising:
receiving updated personal information from the customer, the updated personal information including at least one of changes to the personal information and additional items of personal information; and
updating at least one offer for presentation to the customer in response to the updated personal information.

12. The method of claim 7, further comprising transmitting a contact message to the client device from the electronic site of the first vendor, wherein the contact message includes information for use in forming a contractual relationship between a customer using the client device and the first vendor in response to acceptance of the offer.

13. The method of claim 7, wherein the first vendor includes at least one vendor in a first vendor set and the second vendor includes at least one vendor in a second vendor set.

14. An apparatus comprising:
means for transmitting information of an offer from a first vendor to a client device accessing an electronic site of a second vendor, the offer including information of at least one of goods and services offered for sale by the first vendor, the offer further including a discount corresponding to at least one of goods and services offered for sale by the second vendor;
means for receiving an electronic message from the client device that indicates acceptance of the offer;
means for reducing a purchase price of at least one of the goods and services offered for sale by the second vendor in response to the electronic message, wherein the reducing is commensurate with the discount; and
means for transmitting a message to an electronic site of the first vendor indicating acceptance of the offer.

15. The apparatus of claim 14, further comprising means for generating information of a net present value of a customer using the client device, the net present value representing a total value corresponding to at least one of a plurality of offers from at least one of a plurality of vendors operating vendor electronic commerce sites, wherein the plurality of offers includes the offer and the plurality of vendors includes the first and second vendor.

16. The apparatus of claim 14, further comprising:
means for receiving personal information from a customer using the client device; and
means for selecting the offer for presentation to the customer in response to an item of the personal information.

17. The apparatus of claim 16, further comprising means for generating a plurality of additional offers in response to a plurality of items of the personal information.

18. The apparatus of claim 16, further comprising:
means for receiving updated personal information from the customer, the updated personal information including at least one of changes to the personal information and additional items of personal information; and
means for updating at least one offer for presentation to the customer in response to the updated personal information.

19. The apparatus of claim 14, further comprising means for transmitting a contact message to the client device from the electronic site of the first vendor, wherein the contact message includes information for use in forming a contractual relationship between a customer using the client device and the first vendor in response to acceptance of the offer.

20. The apparatus of claim 14, wherein the first vendor includes at least one vendor in a first vendor set and the second vendor includes at least one vendor in a second vendor set.
